(19) United States
(12) Patent Application Publication
(10) Pub. No.: US 2026/0149349 A1
(43) Pub. Date: May 28, 2026

(54) POWER CONVERTER AND CONTROL CIRCUIT AND CONTROL METHOD THEREOF

(71) Applicant: Joulwatt Technology Co., Ltd., Hangzhou City (CN)

(72) Inventors: Yang YANG, Hangzhou (CN); Changwei GONG, Hangzhou (CN)

(21) Appl. No.: 19/384,319

(22) Filed: Nov. 10, 2025

(30) Foreign Application Priority Data
Nov. 27, 2024 (CN) 202411718374.7

(51) Int. Cl. H02M 1/00; H02M 1/092; H02M 1/42; H02M 7/217

(52) U.S. Cl. CPC H02M 1/0012; H02M 1/0025; H02M 1/007; H02M 1/092; H02M 1/42; H02M 7/217

(57) ABSTRACT

The present disclosure provides a power converter and control circuit and control method thereof. A reference pulse signal is generated by modulating switching frequency information and/or current reference information on a secondary side of the power converter. The pulse signal is transmitted to a primary side through a digital isolator, so that a primary-side control signal could be obtained by demodulating the reference pulse signal on the primary side, and control of a switching state of a power transistor on the primary side is achieved. Wherein, the present disclosure uses special modulation and demodulation settings to transmit several information between the secondary side and primary side through a single channel, the number of isolation devices used between the primary side and secondary side is reduced, system structure is simplified, and system costs are reduced.

### CROSS REFERENCE TO THE RELATED APPLICATIONS

This present disclosure claims priority to a Chinese patent application No. 202411718374.7, filed on November 27, 2024, and entitled "power converter and control circuit and control method thereof", the entire contents of which are incorporated herein by reference, comprising the specification, claims, drawings and abstract.

### FIELD OF TECHNOLOGY

The present disclosure relates to a field of switching power supplies, particularly, to a power converter and a control circuit and a control method thereof.

### BACKGROUND

Switching power supplies are widely used in industrial fields due to their advantages of high efficiency and ability to achieve voltage regulation. Switching power supplies need to detect output voltage or current information and feed it back to a control circuit to control on/off of power transistors and achieve energy transfer.

A feedback path of switching power supply is classified as either isolated or non-isolated, depending on safety-standard requirements. Isolated feedback uses isolation devices to disconnect the feedback path to meet safety regulations. Commonly used isolation methods for isolated feedback comprise magnetic isolation, optocoupler isolation, and capacitor isolation. Among them, optocoupler isolation has relatively high-power consumption, slow speed, short lifespan, and severe performance degradation under high temperature and high irradiation. Magnetic isolation or capacitive isolation utilizes transient magnetic or electric fields to discretely feedback output information to control circuits, with low power consumption, fast speed, long lifespan, and suitable for extreme environments.

A control technology of isolated feedback comprises two types: primary feedback control and secondary feedback control. Primary side feedback control refers to coupling an output signal to a primary side for sampling and holding during a demagnetization stage of a transformer through a winding. A feedback signal comprises a one cycle delay, resulting in poor dynamic response of the system and inability to dynamically regulate the output voltage. Secondary side feedback control refers to obtaining feedback signals from a secondary side of a power converter, and then comparing them with a reference signal to regulate a working state of the converter. Due to real-time feedback output signal of the secondary side feedback control method, the system has good dynamic response and the output voltage can be dynamically regulated.

Due to the need to transmit several information from the secondary side to the primary side in certain situations, it becomes particularly important to achieve multi-information transmission from the secondary side to the primary side with low costs.

### SUMMARY OF THE DISCLOSURE

In order to solve the above technical issues, the present disclosure provides a power converter, a control circuit and a control method thereof, so as to achieve multi-information transmission from the secondary side to the primary side in the power converter with low costs.

According to a first aspect of the present disclosure, a control circuit of a power converter is provided, the power converter comprising a power conversion unit and the control circuit, the power conversion unit comprising a transformer, a power transistor coupled to a primary winding of the transformer, and a rectifier transistor coupled to a secondary winding of the transformer, the control circuit comprising:

a secondary-side control circuit, configured to obtain frequency information and/or current reference information in accordance with an error signal, generate a reference pulse signal by modulating obtained information, and obtain the error signal by amplifying and compensating an error between an output feedback voltage of the power converter and a preset reference voltage;

a digital isolator, coupled to the secondary-side control circuit, configured to transmit the reference pulse signal; and

a primary-side control circuit, coupled to the digital isolator, configured to demodulate the reference pulse signal to obtain a primary-side control signal, the primary-side control signal controlling a switching state of the power transistor.

Optionally, the power converter further comprises a power factor correction circuit cascaded with the power conversion unit;

the secondary-side control circuit is further configured to modulate enable information of the power factor correction circuit onto the reference pulse signal, the enable information of the power factor correction circuit being obtained in accordance with output demand of the power converter.

Optionally, the primary-side control circuit is further configured to:

demodulate the reference pulse signal to obtain a first enable signal, the first enable signal being used to control whether the power factor correction circuit is enabled.

Optionally, the secondary-side control circuit is configured to:

set a pulse frequency of the reference pulse signal in accordance with the switching frequency information to achieve modulation of the switching frequency information.

Optionally, the secondary-side control circuit is configured to:

set effective pulse width duration of the reference pulse signal in accordance with the current reference information to achieve modulation of the current reference information.

Optionally, the reference pulse signal comprises a minimum effective pulse width duration;

the secondary-side control circuit is configured to:

determine whether to set an invalid pulse width with a first duration within the minimum effective pulse width duration of the reference pulse signal in accordance with the enable information of the power factor correction circuit, so as to modulate the enable information of the power factor correction circuit onto the reference pulse signal.

Optionally, the primary-side control circuit comprises:

a conduction control unit, configured to generate a primary-side conduction control signal upon detecting a trigger edge of the reference pulse signal.

Optionally, the primary-side control circuit comprises:

a turn-off control unit, configured to obtain the current reference signal in accordance with the effective pulse width duration of the reference pulse signal, and generate a primary-side turn-off control signal upon a sampling signal representing an inductor current reaching the current reference signal.

Optionally, the primary-side control circuit comprises:

a first enable control unit, configured to generate an effective first enable signal upon detecting the invalid pulse width with the first duration within the minimum effective pulse width duration of the reference pulse signal, and generate an ineffective first enable signal upon detecting no invalid pulse width within the effective pulse width duration of the reference pulse signal,

the effective first enable signal being used to control enablement of the power factor correction circuit, and the ineffective first enable signal being used to control non-enablement of the power factor correction circuit.

Optionally, the digital isolator comprises a magnetic isolator or a capacitive isolator.

According to a second aspect of the present disclosure, a power converter is provided and comprises the control circuit according to any embodiment of the present disclosure.

According to a third aspect of the present disclosure, a control method of a power converter is provided, the power converter comprising a power conversion unit, the power conversion unit comprising a transformer, a power transistor coupled to a primary winding of the transformer, and a rectifier transistor coupled to a secondary winding of the transformer, the control method comprising:

obtaining an error signal by amplifying and compensating an error between an output feedback voltage of the power converter and a preset reference voltage, and obtaining switching frequency information and/or current reference information in accordance with the error signal, the error signal being used to indicate a change of an output voltage of the power converter;

generating a reference pulse signal by modulating obtained information;

transmitting the reference pulse signal from a secondary side to a primary side of the power converter by use of a digital isolator;

demodulating the reference pulse signal to obtain a primary-side control signal on the primary side of the power converter, the primary-side control signal controlling a switching state of the power transistor.

Optionally, the power converter further comprises a power factor correction circuit cascaded with the power conversion unit;

before modulating the obtained information, further comprises:

obtaining enable information of the power factor correction circuit in accordance with output demand of the power converter, so as to modulate the enable information of the power factor correction circuit onto the reference pulse signal.

Optionally, further comprising: demodulating the reference pulse signal to obtain a first enable signal, the first enable signal being used to control whether the power factor correction circuit is enabled.

The beneficial effects of the present disclosure comprise at least:

The present embodiment provides a scheme for information transmission between the secondary side and the primary side of the power converter, which comprises modulating the switching frequency information and/or current reference information onto a reference pulse signal on the secondary side, and then transmitting the reference pulse signal to the primary side by use of the digital isolator. Compared with the prior art, the present embodiment uses special modulation and demodulation settings to transmit several information between the secondary side and primary side through a single channel, the number of isolation devices used between the primary side and secondary side is reduced, system structure is simplified, and system costs are reduced.

In further specific embodiments, in addition to modulating the switching frequency information and/or current reference information onto the reference pulse signal on the secondary side, the control method further comprises modulating the enable information of the power factor correction circuit obtained on the secondary side onto the same reference pulse signal, thereby enabling the transmission of more information through the single channel with wider application.

It should be noted that the above general description and the subsequent detailed description are only exemplary and explanatory, and cannot limit the scope of the present disclosure.

### BRIEF DESCRIPTION OF THE DRAWINGS

FIG. 1 shows a schematic diagram of a power converter;

FIG. 2 shows a schematic diagram of a power converter according to an embodiment of the present disclosure;

FIG. 3 shows a schematic diagram of a control chip according to an embodiment of the present disclosure;

FIG. 4 shows a schematic diagram of a primary-side control circuit in FIG. 3;

FIG. 5 shows a principle schematic diagram of signal modulation on a secondary side of a power converter according to an embodiment of the present disclosure;

FIG. 6 shows a principle schematic diagram of signal demodulation on a primary side of a power converter according to an embodiment of the present disclosure;

FIG. 7 shows a schematic diagram of a reference pulse signal transmitted from a secondary side to a primary side in a power converter according to an embodiment of the present disclosure;

FIG. 8 shows a schematic diagram of a reference pulse signal transmitted from a secondary side to a primary side in a power converter according to another embodiment of the present disclosure;

FIG. 9 shows a flowchart of a control method of a power converter according to an embodiment of the present disclosure.

### DETAILED DESCRIPTION OF THE DISCLOSURE

To facilitate understanding of the present disclosure, a more comprehensive description will now be given with reference to the accompanying drawings. The drawings illustrate preferred embodiments of the present disclosure. It should be understood, however, that the present disclosure may be practiced in many forms other than those specifically set forth herein. On the contrary, the purpose of providing these embodiments is to make the disclosure of the present disclosure more thorough and complete.

In the description of the present disclosure, the reference to "one embodiment" or "some embodiments" means that one or more embodiments of the present disclosure comprise specific features, structures, or characteristics described in conjunction with that embodiment. Therefore, the phrases "in one embodiment," "in some embodiments," "in other embodiments," "in still other embodiments," etc., appearing in different places in this specification do not necessarily refer to the same embodiment, but mean "one or more but not all embodiments," unless otherwise specifically emphasized. The terms "comprising," "including," "having," and their derivatives mean "comprising but not limited to," unless otherwise specifically emphasized.

In the description of the present disclosure, the words "exemplary" or "for example" are used to indicate examples, illustrations, or explanations. Any embodiment described as "exemplary" or "for example" in the present disclosure should not be interpreted as more preferred or advantageous than other embodiments. The term "and/or" in the present disclosure is a description of the relationship between related objects, indicating that there can be three relationships, for example, A and/or B, which can represent: A alone, A and B together, B alone. "Coupling" describes the connection relationship between related objects, for example, A is coupled to B, which can indicate that A and B are directly connected, or A and B are indirectly connected through other devices/units/modules. "Multiple" refers to two or more. In addition, to facilitate a clear description of the technical solution of the embodiments of the present disclosure, the terms "first," "second," etc., are used to distinguish items or similar items with the same or similar functions and roles. Those skilled in the art can understand that the terms "first," "second," etc., do not limit the quantity and execution order, and the terms "first," "second," etc., also do not limit that they must be different.

Furthermore, the same reference numerals in the figures represent the same or similar structures, so the repeated description of them will be omitted, that is, each part of this specification describes in a combination of parallel and progressive ways, with each part focusing on the differences from other parts, and the same or similar parts between each part can be referred to each other.

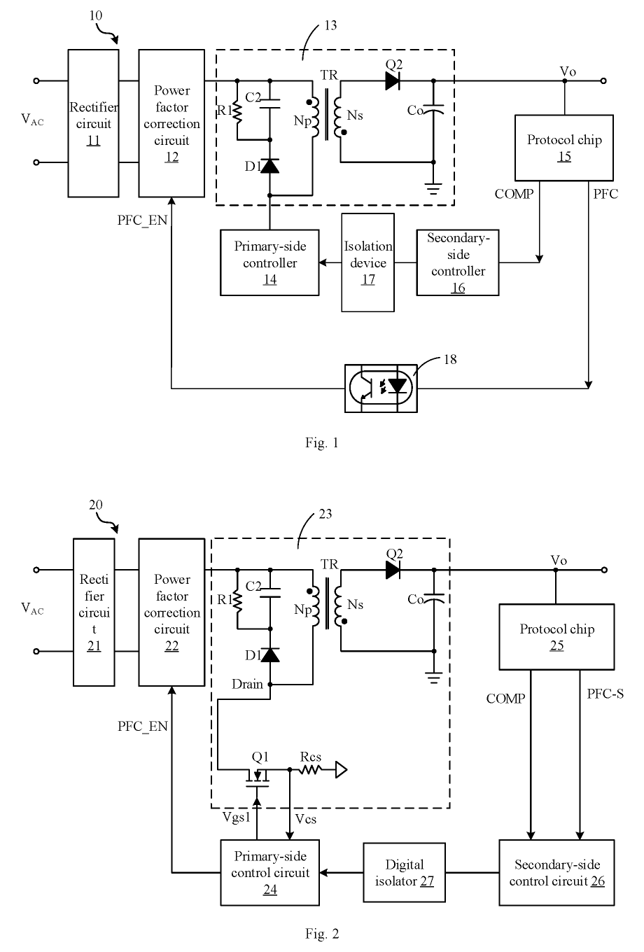

FIG. 1 shows an exemplary schematic diagram of a power converter. As shown in FIG. 1, the power converter 10 comprises a rectifier circuit 11, a power factor correction circuit 12, a power conversion unit 13, a primary-side controller 14, a protocol chip 15, and a secondary-side controller 16. The power conversion unit 13 comprises a transformer TR, a primary circuit (comprising a circuit capable of recovering energy, composed of resistor R1, capacitor C2, and diode D1) coupled to a primary winding Np of the transformer TR, and a secondary circuit (comprising rectifier transistor Q2 and output capacitor Co) coupled to a secondary winding Ns of the transformer TR.

The secondary-side feedback control scheme of the power converter 10 comprises using the protocol chip 15 on the secondary side to obtain an error signal COMP in accordance with the output voltage Vo of the power converter 10, and transmitting this error signal COMP to the primary-side controller 14 on the primary side via the secondary-side controller 16 and an isolation device 17, and then the primary-side controller 14 determines the corresponding current reference and frequency control curves by parsing the received signal, and controls the power through peak current control.

In Power Delivery (PD) fast charging applications, for example, in applications above 75W, the power factor correction circuit 12 and the power conversion unit 13 of the power converter 10 form a cascaded architecture. In this case, the protocol chip 15 can also generate an enable control signal PFC for the power factor correction circuit 12. The enable control signal PFC is transmitted to the power factor correction circuit 12 on the primary side via a corresponding optocoupler isolation device 18, so as to achieve enable control of the power factor correction circuit 12 under different working conditions.

It could be understood that the secondary-side feedback (also known as secondary-side main control) scheme shown in FIG. 1 requires multiple isolation devices to achieve the transfer of various control information from the secondary side to the primary side. For example, only switching frequency information is transmitted through the isolation device 17, and current reference information should be obtained by performing other conversions on frequency information by the primary-side controller 14. It is impossible to directly decouple the switching frequency information and current reference information, not limited to efficiency optimization under different power conditions. Furthermore, in some application scenarios, in order to optimize the enable control of the power factor correction circuit 12, an additional optocoupler isolation device is required for communication between the protocol chip 15 and the primary side, increasing the complexity of the system.

FIG. 2 shows an exemplary schematic diagram of a power converter according to an embodiment of the present disclosure, which is updated and optimized to solve the problems in the power converter shown in FIG. 1.

As shown in FIG. 2, in this embodiment, the power converter 20 comprises: a rectifier circuit 21, a power factor correction circuit 22, a power conversion unit 23, and a control circuit. The rectifier circuit 21, power factor correction circuit 22, and power conversion unit 23 are cascaded between input terminal and output terminal of the power converter 20. The control circuit is coupled to the power conversion unit 23 to control the power conversion of the power conversion unit 23.

The rectifier circuit 21 is configured to rectify the alternating current signal V_{AC} received at the input terminal. When the input signal of the power converter 20 is a direct current signal, the rectifier circuit 21 can be omitted. The specific structure of the rectifier circuit 21 can be understood by referring to the prior art.

The power factor correction circuit 22 is configured to improve the power factor of the input signal. The specific structure of the power factor correction circuit 22 can be understood by referring to existing technical solutions. In some embodiments, the power factor correction circuit 22 can also be omitted.

The power conversion unit 23 comprises a transformer TR with primary winding Np and secondary winding Ns, a voltage input circuit coupled to the primary winding Np, and a power transistor Q1, and a voltage output circuit and a rectifier transistor Q2 coupled to the secondary winding Ns.

In the example shown in FIG. 2, the voltage input circuit comprises an energy recovery circuit (such as a circuit comprising resistor R1, capacitor C2, and diode D1) coupled between the dotted terminal and non-dotted terminal of the primary winding Np. The voltage output circuit comprises a capacitor Co coupled between the secondary winding Ns and the output terminal of the power converter 20. In some other examples, the electrical energy converted by the power converter 20 further passes through a filter before reaching the load coupled to the output terminal.

The power transistor Q1 and sampling resistor Rcs are series-coupled between the primary winding Np and the reference ground, and the rectifier transistor Q2 is coupled between the secondary winding Ns and the voltage output circuit. In the example shown in FIG. 2, the power transistor Q1 uses an NMOS field-effect transistor, and the rectifier transistor Q2 uses a diode. In some other embodiments, the rectifier transistor Q2 can also use an NMOS field-effect transistor to achieve synchronous rectification. In some other embodiments, the power converter 20 may not comprise a sampling resistor Rcs.

The control circuit comprises a primary-side control circuit 24, a protocol chip 25, a secondary-side control circuit 26, and a digital isolator 27. The primary-side control circuit 24 is located on the primary side of the power converter 20, and the secondary-side control circuit 26 and protocol chip 25 are located on the secondary side of the power converter 20. The protocol chip 25 is coupled to the output terminal of the power converter 20, and the secondary-side control circuit 26 is coupled to the output terminal of the protocol chip 25. The digital isolator 27 is coupled between the primary-side control circuit 24 and the secondary-side control circuit 26.

The protocol chip 25 is configured to detect the output status of the power converter 20 (comprising the magnitude of the output signal and/or the connection status of the load, where the output signal comprises output voltage Vo, output current, output power, etc.), and outputs corresponding indication signals in accordance with the detection results.

For embodiments where the power converter 20 comprises a power factor correction circuit 22, the indication signals output by the protocol chip 25 comprise error signal COMP and first enable indication signal PFC-S. For embodiments where the power converter 20 does not comprise a power factor correction circuit 22, the indication signals output by the protocol chip 25 comprise error signal COMP. The error signal COMP is used to indicate the change in the output voltage Vo and the change in the load, and the first enable indication signal PFC-S is used to indicate the enable information of the power factor correction circuit 22. The specific structure of the protocol chip 25 can be understood by referring to existing technical solutions.

It should be noted that in the example shown in FIG. 2, the error signal COMP is generated by an error amplification circuit integrated inside the protocol chip 25 and a compensation loop (not shown) set outside the protocol chip 25 and connected to the error signal output pin of the protocol chip 25. However, in some other embodiments, the error amplification circuit can also be set outside the protocol chip 25. The error amplification circuit is configured to amplify the error between the output feedback voltage (representing the output voltage) and the preset reference voltage, and the compensation loop is configured to compensate for the output results of the error amplification circuit.

The first enable indication signal PFC-S is obtained by the protocol chip 25 in accordance with user-set output demand of the power converter.

The secondary-side control circuit 26 obtains switching frequency information and/or current reference information in accordance with the error signal COMP and modulates obtained information to generate a reference pulse signal. For embodiments where the power converter 20 comprises a power factor correction circuit 22, the secondary-side control circuit 26 also obtains the enable information of the power factor correction circuit in accordance with the first enable indication signal PFC-S and modulates the enable information of the power factor correction circuit onto the reference pulse signal, in addition to modulating the switching frequency information and/or current reference information onto the reference pulse signal, so that a single reference pulse signal can represent multiple types of information that need to be transmitted from the secondary side to the primary side.

The digital isolator 27 is configured to achieve electrical isolation between the primary-side control circuit 24 and the secondary-side control circuit 26, while establishing a communication link between the primary-side control circuit 24 and the secondary-side control circuit 26 to transmit the reference pulse signal. Optionally, the digital isolator 27 can be a magnetic isolator or a capacitive isolator, avoiding the problem of short service life.

The primary-side control circuit 24 is configured to demodulate the reference pulse signal to obtain primary-side control information, and the primary-side control information controls the switching state of the power transistor Q1.

For embodiments where the power converter 20 does not comprise a power factor correction circuit 22, the primary-side control circuit 24 obtains at least one of the corresponding primary-side conduction control signal (denoted as Vgs1_on) and primary-side turn-off control signal (denoted as Vgs1_off) after demodulating the reference pulse signal. For embodiments where the power converter 20 comprises a power factor correction circuit 22, the primary-side control circuit 24 obtains the corresponding primary-side conduction control signal (denoted as Vgs1_on) and primary-side turn-off control signal (denoted as Vgs1_off), and a first enable signal (denoted as PFC_EN) after demodulating the reference pulse signal. The first enable signal PFC_EN controls whether the power factor correction circuit 22 is enabled or not, the primary-side conduction control signal Vgs1_on controls the conduction of the power transistor Q1, and the primary-side turn-off control signal Vgs1_off controls the turn-off of the power transistor Q1. In the example shown in FIG. 2, the primary-side control circuit 24 is also coupled to the control terminal of the power transistor Q1 and one terminal of the sampling resistor Rcs, providing a drive signal Vgs1 to the control terminal of the power transistor Q1 in accordance with the primary-side conduction control signal Vgs1_on and the primary-side turn-off control signal Vgs1_off, controlling the conduction and turn-off of the power transistor Q1.

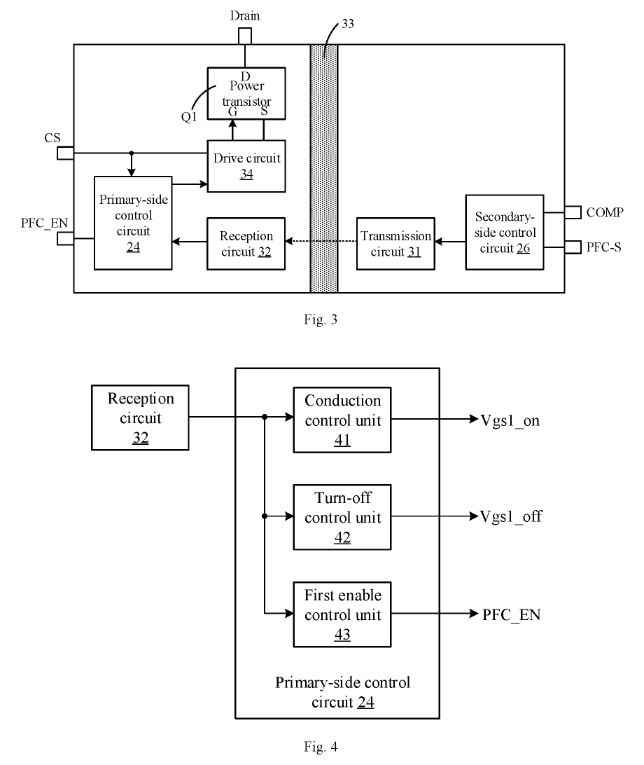

In some embodiments, as shown in FIG. 3, the digital isolator 27 comprises a transmission circuit 31 and a reception circuit 32, which are isolated by an isolation wall 33, that is, the isolator 33 is configured to isolate the circuit modules on the primary side of the power converter 20 and the circuit modules on the secondary side. In the example shown in FIG. 3, the power transistor Q1, the primary-side control circuit 24, and the reception circuit 32 of the digital isolator 27 are set on one side of the isolation wall 33 (i.e., the primary side), and the secondary-side control circuit 26 and the transmission circuit 31 of the digital isolator 27 are set on the other side of the isolation wall 33 (i.e., the secondary side). In some embodiments, the control circuit also comprises a drive circuit 34 set on the primary side of the isolation wall 33, which is connected to the gate G, source S of the power transistor Q1, and the primary-side control circuit 24.

### The working principle of this control circuit is described step by step below:

### 1. Information Modulation

### 1.1 Modulation of Switching Frequency Information

When it is necessary to modulate the switching frequency information, the secondary-side control circuit 26 is configured to set the pulse frequency of the reference pulse signal in accordance with the switching frequency information, thereby achieving modulation of the switching frequency information.

In specific implementation, the secondary-side control circuit 26, in accordance with the error signal COMP received from the error amplification circuit or the protocol chip 25, determines the switching frequency value according to the correspondence between the error signal COMP and the switching frequency fs shown in FIG. 5, and sets the pulse frequency of the reference pulse signal in accordance with the determined switching frequency value.

In this way, the switching frequency information contained in the error signal COMP can be modulated onto the reference pulse signal, thereby using the pulse frequency parameter of the reference pulse signal to represent the switching frequency information and achieving modulation of the switching frequency information.

### 1.2 Modulation of Current Reference Information

When it is necessary to modulate the current reference information, the secondary-side control circuit 26 is configured to set the effective pulse width time of the reference pulse signal in accordance with the current reference information, thereby achieving modulation of the current reference information.

In specific implementation, the secondary-side control circuit 26, in accordance with the error signal COMP received from the error amplification circuit or the protocol chip 25, determines the effective pulse width time value representing the current reference information according to the correspondence between the error signal COMP and the effective pulse width time ton shown in FIG. 5, and sets the effective pulse width time of the reference pulse signal in accordance with the determined effective pulse width time value.

In this way, the current reference information contained in the error signal COMP can be modulated onto the reference pulse signal, thereby using the effective pulse width time parameter of the reference pulse signal to represent the current reference information and achieving modulation of the current reference information.

In this embodiment, the high-level pulse width of the reference pulse signal is defined as the effective pulse width of the reference pulse signal. Of course, in some other embodiments, the low-level pulse width of the reference pulse signal can also be defined as the effective pulse width of the reference pulse signal.

It should be noted that since the reference pulse signal uses different parameters to represent the switching frequency information and current reference information in this embodiment, frequency and current reference can be decoupled in design, that is, the values of the two can be designed independently upon using the reference pulse signal to represent the switching frequency and current reference, compared to the existing modulation method that uses the frequency parameter of the reference pulse signal to represent the current reference information, the scheme of this embodiment can achieve efficiency optimization under different power conditions.

### 1.3 Modulation of Enable Information for Power Factor Correction Circuit

When it is necessary to modulate the enable information of the power factor correction circuit, the secondary-side control circuit 26 is configured to determine whether to set an invalid pulse width with a first duration within the minimum effective pulse width time of the reference pulse signal in accordance with the enable information of the power factor correction circuit, so as to modulate the enable information of the power factor correction circuit onto the reference pulse signal.

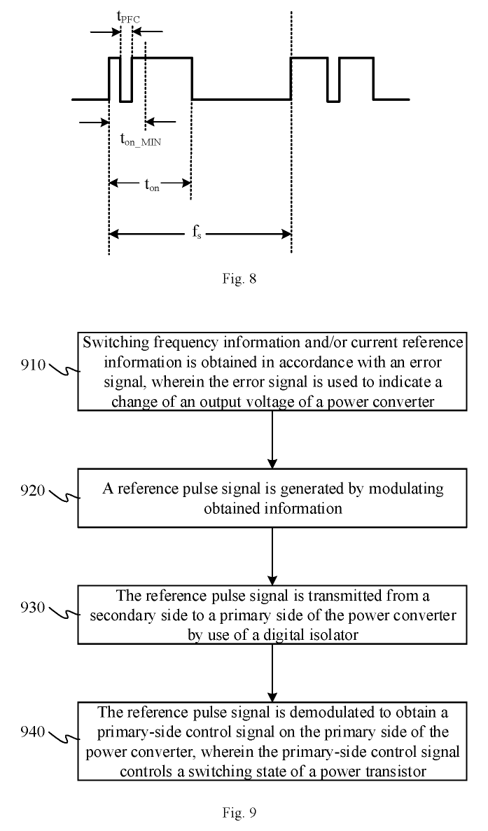

In specific implementation, the secondary-side control circuit 26, in accordance with the first enable indication signal PFC-S output by the protocol chip 25, judges the level state of the first enable indication signal PFC-S, and determines whether to set an invalid pulse width with a first duration within the minimum effective pulse width time of the reference pulse signal in accordance with the level state of the first enable indication signal PFC-S. For example, upon the level state of the first enable indication signal PFC-S being detected as an invalid state (such as a low-level state), it is determined that there is no need to set an invalid pulse width with a first duration within the minimum effective pulse width time of the reference pulse signal. In this case, the waveform of the reference pulse signal that needs to be transmitted is as shown in FIG. 7; upon the level state of the first enable indication signal PFC-S being detected as a valid state (such as a high-level state), it is determined that an invalid pulse width with a first duration needs to be set within the minimum effective pulse width time of the reference pulse signal. In this case, the waveform of the reference pulse signal that needs to be transmitted is as shown in FIG. 8.

Through the above processing, the enable information of the power factor correction circuit contained in the first enable indication signal PFC-S can be modulated onto the reference pulse signal, thereby using whether there is an invalid pulse width within the minimum effective pulse width time of the reference pulse signal to represent the enable information of the power factor correction circuit, achieving modulation of the enable information of the power factor correction circuit.

It should be noted that the minimum effective pulse width time (denoted as ton_MIN) of the reference pulse signal is a preset parameter of the reference pulse signal, as shown in FIG. 8. The minimum effective pulse width time ton_MIN specifically represents the ton_MIN period starting from the rising edge of the reference pulse signal, and the rising edges/falling edges detected within this minimum effective pulse width time are not counted in the determination of the pulse frequency of the reference pulse signal. In this way, it is possible to avoid conflicts in the transmission of current reference information and enable information of the power factor correction circuit upon using the reference pulse signal to transmit multiple types of information.

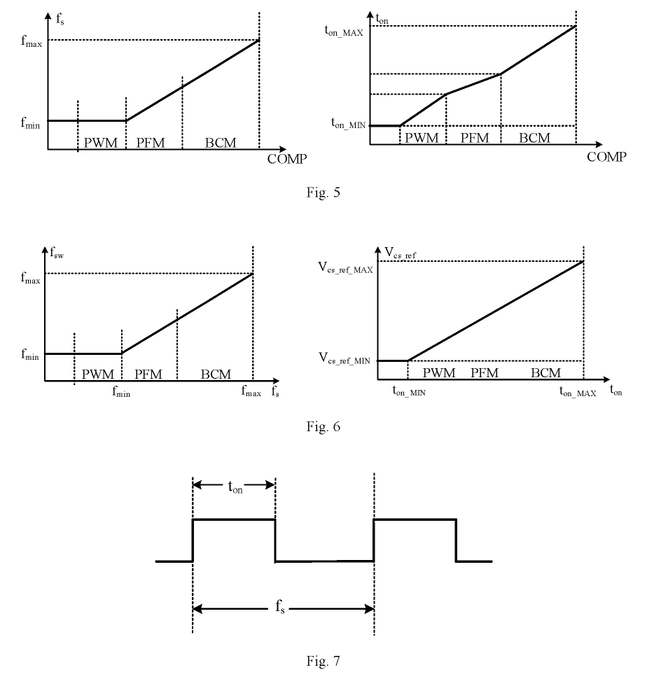

In some examples, as shown in FIG. 6, the minimum effective pulse width time ton_MIN of the reference pulse signal can correspond to a preset minimum value (denoted as Vcs_ref_MIN) of the current reference signal Vcs_ref.

It should be noted that during the modulation process of the enable information of the power factor correction circuit, there is no specific restriction on the size of the first duration.

### 2. Signal Transmission

In this embodiment, a digital isolator (such as a magnetic isolator or a capacitive isolator) 27 is configured to transmit the reference pulse signal from the secondary side to the primary side of the power converter.

When it is necessary to transmit corresponding feedback information from the secondary side to the primary side of the power converter, the secondary-side control circuit 26 sends the reference pulse signal carrying at least one of the switching frequency information, current reference information, and enable information of the power factor correction circuit to the transmission circuit 31 on the secondary side, and then uses non-optical coupling methods such as magnetic coupling or capacitive coupling between the transmission circuit 31 and the reception circuit 32 to transmit the reference pulse signal to the reception circuit 32 on the primary side, achieving signal transmission from the secondary side to the primary side. In this process, since at least one of the information to be transmitted is regulated to the same reference pulse signal, only a single channel provided by the digital isolator 27 is needed to achieve signal transmission of multiple types of information, reducing the number of digital isolators 27 used, thereby reducing system costs and structural complexity.

In addition, compared to optocoupler isolation devices, using a digital isolator 27 for signal transmission between the primary side and secondary side in this embodiment makes the service life of the isolation device longer, effectively solving the problem of the service life of the isolation device.

### 3. Information Demodulation

### 3.1 Demodulation of Switching Frequency Information

In some embodiments, when it is necessary to demodulate the switching frequency information, refer to FIG. 4, the primary-side control circuit 24 comprises a conduction control unit 41, the input terminal of which is coupled to the output terminal of the reception circuit 32. The reception circuit 32 transmits the received reference pulse signal to the conduction control unit 41. The conduction control unit 41, in accordance with the received reference pulse signal, for example, determines the switching frequency fsw of the primary-side control signal according to the correspondence between the pulse frequency fs and the switching frequency fsw shown in FIG. 6, and generates a primary-side conduction control signal Vgs1_on in accordance with the determined switching frequency, achieving demodulation of the switching frequency information contained in the reference pulse signal.

For example, a reference pulse signal with the same frequency as the primary-side control signal can be directly generated on the secondary side, so that the primary-side control circuit 24 generates a primary-side conduction control signal Vgs1_on upon detecting the trigger edge of the reference pulse signal, where the primary-side conduction control signal Vgs1_on is used to achieve conduction control of the power transistor Q1.

It should be noted that the aforementioned trigger edge can be one of the rising edge and the falling edge of the reference pulse signal, and the rising edges and falling edges detected within the minimum effective pulse width time of the reference pulse signal are not counted.

Of course, in some other embodiments, a fixed turn-off time control method can also be used on the primary side of the power converter. In these embodiments, the conduction control unit 41 is configured to start timing at the turn-off moment of the power transistor Q1 and control the power transistor Q1 to conduct after timing to a preset time threshold. In this case, the switching frequency information does not need to be modulated on the secondary side of the power converter, and the switching frequency information does not need to be demodulated on the primary side of the power converter.

### 3.2 Demodulation of Current Reference Information

In some embodiments, when it is necessary to demodulate the current reference information, refer to FIG. 4, the primary-side control circuit 24 comprises a turn-off control unit 42, the input terminal of which is coupled to the output terminal of the reception circuit 32. The reception circuit 32 transmits the received reference pulse signal to the turn-off control unit 42. Based on the received reference pulse signal, the turn-off control unit 42 obtains the current reference signal Vcs_ref (for example, generates the corresponding current reference signal Vcs_ref according to the correspondence between the pulse width time ton and the current reference signal Vcs_ref shown in FIG. 6), and generates a primary-side turn-off control signal Vgs1_off upon the sampling signal Vcs representing the inductor current reaching the current reference signal Vcs_ref, achieving demodulation of the current reference information contained in the reference pulse signal. The primary-side turn-off control signal Vgs1_off is used to achieve turn-off control of the power transistor Q1, and the sampling signal Vcs representing the inductor current can be obtained by sampling the sampling resistor Rcs or other conventional schemes on the primary side.

It should be noted that for embodiments where the power converter 20 comprises a power factor correction circuit 22, that is, upon the reference pulse signal containing enable information of the power factor correction circuit, as shown in FIG. 8, the effective pulse width time ton of the reference pulse signal comprises the first duration t_{PFC}.

Of course, in some other embodiments, a fixed conduction time control method can also be used on the primary side of the power converter. In these embodiments, the turn-off control unit 41 is configured to start timing at the conduction moment of the power transistor Q1 and control the power transistor Q1 to turn off after timing to a preset time threshold. In this case, the current reference information does not need to be modulated on the secondary side of the power converter, and the current reference information does not need to be demodulated on the primary side of the power converter.

### 3.3 Demodulation of Enable Information for Power Factor Correction Circuit

When it is necessary to demodulate the enable information of the power factor correction circuit, refer to FIG. 4, the primary-side control circuit 24 comprises a first enable control unit 43, the input terminal of which is coupled to the output terminal of the reception circuit 32. The reception circuit 32 transmits the received reference pulse signal to the first enable control unit 43. Based on the received reference pulse signal, the first enable control unit 43 is configured to detect whether there is an invalid pulse width with a first duration t_{PFC} within the minimum effective pulse width time ton_MIN of the reference pulse signal. When an invalid pulse width with a first duration t_{PFC} is detected within the minimum effective pulse width time ton_MIN of the reference pulse signal, an effective first enable signal PFC_EN is output to the power factor correction circuit 22, controlling the power factor correction circuit 22 to be enabled, for example, controlling the power factor correction circuit 22 to work normally; upon detecting no invalid pulse width within the minimum effective pulse width time ton_MIN of the reference pulse signal, an ineffective first enable signal PFC_EN is output to the power factor correction circuit 22, controlling the power factor correction circuit 22 to be disabled, for example, controlling the power factor correction circuit 22 not to work or to work in low-power mode.

It can be seen from the above that the signal isolation transmission scheme between the primary side and secondary side disclosed in the embodiments of the present disclosure can use a digital isolator to transmit multiple types of secondary-side feedback information through a single channel, achieving system simplification and solving the service life problem of using optocoupler isolators for signal transmission.

It should be noted that FIG. 2 of the present disclosure takes the rectifier transistor Q2 as a diode as an exemplary illustration, but the scheme of the present disclosure is also applicable when the rectifier transistor Q2 is a synchronous rectifier. In this case, the conduction and turn-off of the synchronous rectifier are controlled by the secondary-side control circuit 26.

Furthermore, the present disclosure takes a common flyback converter as an example to illustrate the technical solution of the present disclosure, but it should be understood that the technical solution disclosed in the present disclosure is also applicable to other types of isolated power converters, such as active clamp flyback converters.

Furthermore, the embodiments of the present disclosure also provide a control method for a power converter, which can be applied to any power converter disclosed in the aforementioned embodiments. Specifically, as shown in FIG. 9, the control method comprises executing the following steps:

In step 910, switching frequency information and/or current reference information is obtained in accordance with an error signal, wherein the error signal is used to indicate a change of an output voltage of a power converter.

In this step, the error signal represents load changes can be obtained by use of an error amplification circuit and a compensation loop, and the switching frequency information and/or current reference information can be obtained in accordance with the error signal.

In some embodiments, upon the power converter further comprising a power factor correction circuit cascaded with a power conversion unit, the control method further comprises: obtaining enable information of the power factor correction circuit in accordance with output demand of the power converter, so as to modulate the enable information of the power factor correction circuit onto the reference pulse signal. For example, a protocol chip can be used to detect the output demand of the power converter and obtain the enable information of the power factor correction circuit in accordance with detection results.

In some embodiments, the error amplification circuit can be directly integrated into the protocol chip, so that at least two of the switching frequency information, current reference information, and enable information of the power factor correction circuit can be directly obtained in accordance with the output results of the protocol chip.

In step 920, a reference pulse signal is generated by modulating obtained information.

In step 930, the reference pulse signal is transmitted from a secondary side to a primary side of the power converter by use of a digital isolator.

In this step, the digital isolator comprises but is not limited to magnetic isolators or capacitive isolators.

In step 940, the reference pulse signal is demodulated to obtain a primary-side control signal on the primary side of the power converter, wherein the primary-side control signal controls a switching state of a power transistor.

Furthermore, when the power converter further comprises a power factor correction circuit cascaded with the power conversion unit, step 940 further comprises obtaining a first enable signal in accordance with the demodulation of the reference pulse signal, wherein the first enable signal is used to control whether the power factor correction circuit is enabled.

Specifically, the specific implementation and technical effects that can be achieved by each step of the control method for the power converter described above can refer to the aforementioned embodiments of the power converter, which will not be repeated here.

Finally, it should be noted that the aforementioned embodiments are merely examples made to clearly illustrate the present disclosure and are not a limitation on the implementation methods. For ordinary technicians in the field, other different forms of changes or modifications can also be made on the basis of the aforementioned description. It is not necessary and impossible to exhaust all implementation methods here. The obvious changes or modifications derived therefrom are still within the protection scope of the present disclosure.

What is claimed is:

1. A control circuit of a power converter, the power converter comprising a power conversion unit and the control circuit, the power conversion unit comprising a transformer, a power transistor coupled to a primary winding of the transformer, and a rectifier transistor coupled to a secondary winding of the transformer, the control circuit comprising:
a secondary-side control circuit, configured to obtain frequency information and/or current reference information in accordance with an error signal, generate a reference pulse signal by modulating obtained information, and obtain the error signal by amplifying and compensating an error between an output feedback voltage of the power converter and a preset reference voltage;
a digital isolator, coupled to the secondary-side control circuit, configured to transmit the reference pulse signal; and
a primary-side control circuit, coupled to the digital isolator, configured to demodulate the reference pulse signal to obtain a primary-side control signal, the primary-side control signal controlling a switching state of the power transistor.

2. The control circuit according to claim 1, wherein the power converter further comprises a power factor correction circuit cascaded with the power conversion unit;
the secondary-side control circuit is further configured to modulate enable information of the power factor correction circuit onto the reference pulse signal, the enable information of the power factor correction circuit being obtained in accordance with output demand of the power converter.

3. The control circuit according to claim 2, wherein the primary-side control circuit is further configured to:
demodulate the reference pulse signal to obtain a first enable signal, the first enable signal being used to control whether the power factor correction circuit is enabled.

4. The control circuit according to claim 1, wherein the secondary-side control circuit is configured to:
set a pulse frequency of the reference pulse signal in accordance with the switching frequency information to achieve modulation of the switching frequency information.

5. The control circuit according to claim 1, wherein the secondary-side control circuit is configured to:
set effective pulse width duration of the reference pulse signal in accordance with the current reference information to achieve modulation of the current reference information.

6. The control circuit according to claim 2, wherein the reference pulse signal comprises a minimum effective pulse width duration;
the secondary-side control circuit is configured to:
determine whether to set an invalid pulse width with a first duration within the minimum effective pulse width duration of the reference pulse signal in accordance with the enable information of the power factor correction circuit, so as to modulate the enable information of the power factor correction circuit onto the reference pulse signal.

7. The control circuit according to claim 4, wherein the primary-side control circuit comprises:
a conduction control unit, configured to generate a primary-side conduction control signal upon detecting a trigger edge of the reference pulse signal.

8. The control circuit according to claim 5, wherein the primary-side control circuit comprises:
a turn-off control unit, configured to obtain the current reference signal in accordance with the effective pulse width duration of the reference pulse signal, and generate a primary-side turn-off control signal upon a sampling signal representing an inductor current reaching the current reference signal.

9. The control circuit according to claim 6, wherein the primary-side control circuit comprises:
a first enable control unit, configured to generate an effective first enable signal upon detecting the invalid pulse width with the first duration within the minimum effective pulse width duration of the reference pulse signal, and generate an ineffective first enable signal upon detecting no invalid pulse width within the effective pulse width duration of the reference pulse signal,
the effective first enable signal being used to control enablement of the power factor correction circuit, and the ineffective first enable signal being used to control non-enablement of the power factor correction circuit.

10. The control circuit according to claim 1, wherein the digital isolator comprises a magnetic isolator or a capacitive isolator.

11. A power converter, comprising: a control circuit according to claim 1.

12. A control method of a power converter, the power converter comprising a power conversion unit, the power conversion unit comprising a transformer, a power transistor coupled to a primary winding of the transformer, and a rectifier transistor coupled to a secondary winding of the transformer, the control method comprising:
obtaining an error signal by amplifying and compensating an error between an output feedback voltage of the power converter and a preset reference voltage, and obtaining switching frequency information and/or current reference information in accordance with the error signal, the error signal being used to indicate a change of an output voltage of the power converter;
generating a reference pulse signal by modulating obtained information;
transmitting the reference pulse signal from a secondary side to a primary side of the power converter by use of a digital isolator;
demodulating the reference pulse signal to obtain a primary-side control signal on the primary side of the power converter, the primary-side control signal controlling a switching state of the power transistor.

13. The control method according to claim 9, wherein the power converter further comprises a power factor correction circuit cascaded with the power conversion unit;
before modulating the obtained information, further comprises:
obtaining enable information of the power factor correction circuit in accordance with output demand of the power converter, so as to modulate the enable information of the power factor correction circuit onto the reference pulse signal.

14. The control method according to claim 13, further comprising: demodulating the reference pulse signal to obtain a first enable signal, the first enable signal being used to control whether the power factor correction circuit is enabled.
